(19) United States
(12) Patent Application Publication
(10) Pub. No.: US 2025/0027013 A1
(43) Pub. Date: Jan. 23, 2025

(54) Manganese Bleach Catalyst Granules

(71) Applicant: Novozymes A/S, Bagsvaerd (DK)

(72) Inventors: Pavle Andric, Copenhagen (DK); Kaare Joergensen-Engsted, Saaby (DK); Niels Viktor Nielsen, Dyssegaard (DK); Lei Shang, Smorum (DK)

(73) Assignee: Novozymes A/S, Bagsvaerd (DK)

(21) Appl. No.: 18/909,608

(22) Filed: Oct. 8, 2024

Related U.S. Application Data
(62) Division of application No. 16/080,112, filed on Aug. 27, 2018, now abandoned.

(30) Foreign Application Priority Data
Mar. 11, 2016 (EP) 16159923.8
Nov. 10, 2016 (EP) 16198298.8
Mar. 9, 2017 (WO) PCT/EP2017/055553

(51) Int. Cl. C11D 3/39; C11D 3/395; C11D 17/00

(52) U.S. Cl. CPC C11D 3/392; C11D 3/3932; C11D 3/3935; C11D 17/0039; C11D 3/395

(57) ABSTRACT

The present invention relates to granules comprising a bleach catalyst and to their use in bleach-containing detergents.

### FIELD OF THE INVENTION

The present invention relates to manganese bleach catalyst granules and to their use in bleach-containing compositions. More particularly, it relates to granules wherein the bleach catalyst has improved storage stability, and wherein the loss of bleach catalyst is reduced in the production of bleach catalyst granules.

### BACKGROUND OF THE INVENTION

In automatic dish-washers, it is common to use granular detergents which contain a bleaching agent, such as a hydrogen peroxide precursor like perborate or percarbonate. It is well known to improve the effect of the bleach at low temperatures by adding a bleach catalyst, e.g., a bleach catalyst comprising manganese and a ligand which is di- or trimethyl azacyclononane or a derivative thereof such as MnTACN).

### SUMMARY OF THE INVENTION

The inventors have developed granules comprising a manganese bleach catalyst, which have improved storage stability in bleach containing compositions, and which can be produced with a low loss/recycle of the bleach catalyst.

Accordingly, the invention provides non-enzymatic granules comprising
(a) a core surrounded by
(b) a first coating which comprises bleach catalyst particles and a binder, which is surrounded by
(c) a second coating comprising at least 60% by weight of a water-soluble salt having a constant humidity at 20° C. which is above 85%, which is surrounded by
(d) a third coating;
   wherein the bleach catalyst particles comprise at least 80% by weight of a manganese complex with nitrogen-containing ligands, characterized in that at least 70% by weight of the particles have particle sizes in the range from 1 μm to 50 μm, at most 15% by weight of the particles have particle sizes of >50 μm, and at most 15% by weight of the particles have particle sizes of <1 μm, wherein the percentages are based on the total amount of the particles.

In an embodiment, the bleach catalyst particles have a volume average particle size D₅₀ in the range of 5 to 25 μm.

The invention also provides a method for making the above-mentioned granules of the invention.

Other aspects and embodiments of the invention are apparent from the description and examples.

### FIGURES

FIG. 1 shows Granule (a) from Example 1.

FIG. 2 shows Granule (b) from Example 1.

FIG. 3 shows the heat flow generated by Granules (c) and (d) in Example 2.

### DETAILED DESCRIPTION OF THE INVENTION

The present invention concerns a particularly stable manganese-containing bleach catalyst granule and the process for making it. In the process, the bleach catalyst is applied as a coating onto a core particle, and a salt coating is applied onto the bleach catalyst coating. The bleach catalyst is in the form of small particles that attaches to surface of the core particles.

We have found that it is essential to control the relationship between the core particle size, the bleach catalyst particle size, and the size of the salt coating, in order to reduce loss of bleach catalyst particles (that will not attach to the core particles) in the production process. Thus, it is a particular advantage of the present invention that the amount of bleach catalyst particles that is lost or need to be recycled in the process is very low.

Not only is the loss/recycle of bleach catalyst particles low, but the stability of the bleach catalyst itself is also improved.

Manganese bleach catalyst crystal particles, which are used in ADW applications, are typically produced in size of around 200 microns. In order to be used in ADW detergent, the bleach catalyst particles must be protected from reactive compounds, such as bleaching agents. With a typical granulate size of 300-1200 microns used in the industry, the protective coating of 200 microns bleach catalyst particles on a granule surface is difficult and uneconomical due to high physical losses (>50%). Not only would the process be expensive, but it would also be impossible to obtain a homogenous layer, and to protect the so-formed manganese bleach catalyst layer effectively due to the large primary crystal particle size.

The present invention discloses a stabilized bleach catalyst granule comprises a uniform layer of Manganese bleach catalyst crystal particles. The size of the bleach catalyst crystal particles is in the range of 1-50 microns, and a protective salt coating is applied. A specific ratio is used between the thickness of the coating and the bleach catalyst particle size. If a smaller particle size is used, the process becomes significantly more difficult and expensive. If a larger particle size is used, the layer of bleach catalyst particles becomes inhomogeneous and a high amount of bleach catalyst will be lost in the process, which gives significantly higher costs, as the manganese bleach catalyst is an expensive detergent component.

We have developed a process in which we first reduce bleach catalyst particle size, then apply the particles together with a binder on an inert particle (core) surface, and then coat it with at least one protective salt layer. The amount of binder is important to obtain a stable and uniform coating of the bleach catalyst on the inert particle (core) surface. By protecting the bleach catalyst particles, we also drastically enhance the stability of the catalyst in bleach-containing compositions, such as detergents.

Although particle size reduction can be done with other technologies, a particularly suitable technology for safe and efficient size reduction of the bleach catalyst particles is the milling in a wet state-wet milling. The wet milled manganese bleach catalyst particles of around 25 microns are applied by coating the inert core particles (250-1200 microns) in combination with a binder. This allows rapid, efficient and economical deposition of bleach catalyst particles onto the granules with physical yields of 50-100%. Subsequently, a coating of for example sodium sulfate salt is applied onto the granule, followed by a film layer (third coating) of polymer, kaolin and white pigment. The so formed homogenous layer is a protective coating, which ensures that coated bleach catalyst particles are strongly separated from the oxidative detergent components, e.g., percarbonates.

### Non-Enzymatic Granule

A non-enzymatic granule of the invention is a particle containing a bleach catalyst according to the invention, and no enzymes. The granule may be (roughly) spherical.

The granule typically has an average diameter of 20-2000 μm, particularly 50-1500 μm, 100-1500 μm or 250-1200 μm.

The granule is composed of a core, and one or more coatings (outer layers) surrounding the core.

### Core

The core may include a stabilizer such as a reducing agent/antioxidant and/or a salt of a multivalent cation and/or an acidic buffer component, typically as a homogenous blend. The blend may also include binders (such as synthetic polymer, wax, fat, or carbohydrate). The blend may further include additional materials such as fillers, fibre materials (cellulose or synthetic fibres), stabilizing agents, solubilising agents, suspension agents, viscosity regulating agents, light spheres, plasticizers, salts, lubricants and fragrances.

The core can be prepared by granulating the blend, e.g., by use of granulation techniques including: crystallisation, precipitation, pan-coating, fluid bed coating, fluid bed agglomeration, rotary atomization, extrusion, prilling, spheronization, size reduction methods, drum granulation, and/or high shear granulation.

The core may consist of an inert particle with the blend absorbed into it, or with the blend applied on to the surface, e.g., via fluid bed coating.

The core particle may have a diameter of 20-2000 μm, particularly 50-1500 μm, 100-1500 μm or 250-1200 μm.

Reducing Agent, Peroxide and/or Antioxidant

The core may contain a reducing agent, a peroxide decomposing catalyst and/or an antioxidant (a molecule capable of slowing or preventing the oxidation of other molecules). Examples are sulfites, thiosulfates, erythorbates, ascorbates and nitrites, e.g. as salts of alkali metals and earth alkali metals. Other suitable materials are methionine, cysteine, propyl gallate, tert-butyl hydroquinone, tocopherols, thiodipropionic acid, butylated hydroxytoluene (BHT), butylated hydroxyanisol (BHA) or tannic acid.

The amount of the antioxidant, peroxide decomposing catalyst or reducing agent may be at least 0.1% by weight relative to the core, particularly at least 0.2%, at least 0.5%, or at least 1%. The amount may be at most 10% by weight relative to the core, particularly at most 5%, at most 4%, at most 3%, or at most 2%. Here, the amount of a salt is calculated in anhydrous form. Peroxide decomposing catalysts can be efficient in even lower concentrations, e.g. at least 0.001%, or at least 0.01%; the amount may be at most 5% or at most 1%.

### Salt of a Multivalent Cation

The core may contain a salt of a multivalent cation in the core, particularly a divalent or trivalent cation, e.g., a salt of Mg, Zn, Cu, Mn, Ca or Al. The salt may include an organic or inorganic anion such as sulfate, chloride or acetate. Particular salts include magnesium sulfate and zinc sulfate, e.g. magnesium sulfate heptahydrate.

The salt may be used in an amount of at least 0.1% by weight of the core, particularly at least 0.5% by weight, e.g. at least 1% by weight. The amount may be at most 15%, 10% or 5%. The percentage indicates the amount of the salt in anhydrous form.

The multivalent cation may be used in an amount of at least 0.02% by weight of the core, particularly at least 0.1% by weight, e.g. at least 0.2% by weight. The amount may be at most 6%, at most 4% or at most 2%. The percentage indicates the amount of the multivalent cation.

### Acidic Buffer Component

The core may contain an acidic buffer component (acidic buffering agent) in the core or the coating. The amount may be at least 0.1% by weight of the core, particularly at least 1% by weight. The amount is typically at most 10% by weight of the core, particularly at most 5% by weight. The percentage indicates the amount in anhydrous form.

The acidic buffer component has a pH below 7 when measured as a 1% by weight aqueous solution (or alternatively a 10% solution). The acidic buffer component may have a pH of 1 to below 7, e.g. a pH of 3 to below 7, particularly a pH of 4 to 5. The acidic buffer component is typically a mixture comprising a weak acid and the corresponding base; it is at least partly in its acid form.

Furthermore the acidic buffer component has a pKa from 2 to 9, in particular a pKₐ from 4 to 9, in particular a pKₐ from 5 to 8, in particular a pKₐ from 2 to 6, in particular a pKₐ from 2 to 5, in particular a pKₐ from 2 to 4, in particular a pKₐ from 5 to 7. To utilize most of the potential buffer capacity the pH of an aqueous solution is in general below the pKₐ.

Particularly suitable acidic buffer components are salts of H₃PO₄ e.g. NaH₂PO₄, KH₂PO₄, and Ca(H₂PO₄)₂, polyphosphates e.g. sodium hexametaphosphate, polyacrylic acid and partly neutralized polyacrylic acid and co-polymers thereof, simple organic acids (less than 10 carbon atoms e.g. 6 or less carbon atoms) such as citric acid and salts thereof such as hydrogen citrate, e.g. disodium hydrogen citrate, malonic, succinic, glutaric, adipic acid.

In a particular embodiment the acidic buffer components are selected from the group consisting of polyacrylic acid and partly neutralized polyacrylic acid and co-polymers thereof, citric acid and Na₃-citrate.

### Coatings

The granule comprises a core surrounded by a first, a second, and a third coating. Each coating should form a substantially continuous layer. A substantially continuous layer is to be understood as a coating having few or no holes, so that the core unit it is encapsulating has few or none uncoated areas. The layer or coating should in particular be homogenous in thickness.

### First Coating

The first coating comprises the bleach catalyst and a binder. The amount of the bleach catalyst may be in the range of 2-15% by weight of the core, particularly 3-10%.

The binder may be a carbohydrate binder such as dextrin and/or sucrose, e.g. in an amount of 1-20% by weight of the core.

The average thickness of the first coating is in the range of 1 to 15 μm, preferably 1 to 10 μm.

### Second Coating

The second coating comprises at least 60% by weight of the coating of a salt, e.g. at least 65%, at least 70%, at least 75%, at least 80%, at least 85%, at least 90%, at least 95% or at least 99%.

The second coating may be applied in an amount of at least 10% by weight of the core, e.g. at least 15%, 20%, 30%, or 40%. The amount may be at most 100%, 90%, 80% or 70%.

To provide acceptable protection, the salt coating is preferably at least 5 μm thick, particularly at least 10 μm, at least 15 μm or at least 20 μm. The thicker the coating the more time consuming and expensive it gets to produce the granule. In a particular embodiment the thickness of the salt coating is below 100 μm. In a more particular embodiment the thickness of the salt coating is below 80 μm. In an even more particular embodiment the total thickness of the salt coating is below 50 μm.

The salt may be added from a salt solution where the salt is completely dissolved or from a salt suspension wherein the fine particles is less than 50 μm, such as less than 10 μm or less than 5 μm.

The salt coating is especially effective if it is applied in a fluid bed under relatively high humidity conditions.

The salt coating can further contain other materials as known in the art, e.g. fillers, anti-sticking agents, pigments, dyes, plasticizers and/or binders, such as titanium dioxide, kaolin, calcium carbonate or talc.

### Salts

The salt in the second coating may be an inorganic salt or organic salt. It has a constant humidity at 20° C. above 85%, particularly above 90%, or it may be another hydrate form of such a salt (e.g. anhydrate). The salt coating may be according to WO 00/01793.

The second coating may comprise a single salt or a mixture of two or more salts. The salt may be water soluble, in particular having a solubility at least 0.1 grams in 100 g of water at 20° C., preferably at least 0.5 g per 100 g water, e.g. at least 1 g per 100 g water, e.g. at least 5 g per 100 g water.

Specific examples of suitable salts are Na₂CO₃ (CH_{20° C.}=92%), Na₂HPO₄ (CH_{20° C.}=95%), Na₃PO₄ (CH_{25° C.}=92%), (NH₄)₂HPO₄ (CH_{20° C.}=93%), NH₄H₂PO₄ (CH_{20° C.}=93.1%), K₂HPO₄ (CH_{20° C.}=92%), KH₂PO₄ (CH_{20° C.}=96.5%), KNO₃ (CH_{20° C.}=93.5%), Na₂SO₄ (CH_{20° C.}=93%), K₂SO₄ (CH_{20° C.}=98%), KHSO₄ (CH_{20° C.}=86%), MgSO₄ (CH_{20° C.}=90%), ZnSO₄ (CH_{20° C.}=90%) and sodium citrate (CH_{25° C.}=86%).

The salt may be in anhydrous form, or it may be a hydrated salt, i.e. a crystalline salt hydrate with bound water(s) of crystallization, such as described in WO 99/32595. Specific examples include anhydrous sodium sulfate (Na₂SO₄), anhydrous magnesium sulfate (MgSO₄), magnesium sulfate heptahydrate (MgSO₄(7H₂O)), zinc sulfate heptahydrate (ZnSO₄(7H₂O)), sodium phosphate dibasic heptahydrate (Na₂HPO₄(7H₂O)), and sodium citrate dihydrate.

Preferably the salt it applied as a solution of the salt e.g. using a fluid bed.

### Third Coating

The granule includes an additional third coating on the outside of the salt coating (second coating), e.g. in an amount of at least 0.5% by weight of the core, particularly at least 1%, e.g., at most 20% or 10%.

The third coating may comprise a film-forming agent, such as a film-forming polymer. The film-forming agent be polyethylene glycol (PEG), hydroxypropyl methyl cellulose (HPMC or MHPC), polyvinyl alcohol (PVA) or other film forming agents and can further contain fillers, antisticking agents, pigment, dye, plasticizers etc.

The average total thickness of the second and third coatings may be at least 20 μm, or at least 30 μm, and/or it may be at least 400% of the thickness of the first coating.

The combined second and third coating makes up at least 30% by weight of the core.

Other additional coatings on the inside or outside of the salt coatings may be applied as known for people skilled in the art.

### Bleach Catalyst

The bleach catalyst used as a component of (and to prepare) the granule of the invention is a manganese complex with nitrogen-containing ligands; preferably the nitrogen-containing ligands comprises at least one ligand selected from the group consisting of di- or trimethyltriazacyclononanes and derivates thereof.

In an embodiment, the bleach catalysts are manganese complexes of the oxidation step II, III or in particular IV that contains one or more macrocyclic ligand(s) with the donor functions N and/or NR; where R is a hydrocarbon residue with up to 5 C-atoms, in particular methyl, ethyl or propyl.

Preferred bleach catalysts are manganese complexes with ligands selected from the group 1,4,7-trimethyl-1,4,7-triazacyclononane, 1,4,7-triazacyclononane, 1,5,9-trimethyl-1.[delta].[theta]-triazacyclododecan, 2-methyl-1,4,7-trimethyl-1,4,7-triazacyclononane, 2-methyl-1,4,7-triazacyclononane, 1,2-bis-(4,7-dimethyl-1,4,7-triazacyclo-nono-1-yl) ethane, cyclam or its methyl-substituted derivatives, and/or cyclen or its methyl-substituted derivatives, in particular 1,8-dimethylcyclam, 1,7-dimethylcyclen, 1,8-diethylcyclam, 1,7-diethylcyclen, 1,8-dibenzylcyclam or 1,7-dibenzylcyclen.

Particularly preferred ligands are 1,4,7-trimethyl-1,4,7-triazacyclononane (Me-TACN), 1,4,7-triazacyclononane (TACN) or bridged ligands such as 1,2-bis-(4,7-dimethyl-1,4,7-triazacyclonono-1-yl) ethane (Me4-DTNE), as described for example in EP 0 458 397, EP 0 458 398, EP 0 549 272, EP 0 530 870, WO 96/06154, WO 96/06157 or WO 2006/125517.

The type of counter-ion (e.g., X in formulae 1 and 2 below) for charge neutrality is not critical for the activity of the manganese complex and can be selected from, for example, any of the following counter-ions: chloride; sulphate; nitrate; methylsulphate; surfactant anions, such as the long-chain alkylsulphates, alkylsulphonates, alkylbenzenesulphonates, tosylate; trifluoromethylsulphonate; perchlorate (CIO₄⁻), BPh₄⁻, and PF₆⁻, though some counter-ions are more preferred than others for reasons of product property and safety.

In a particular embodiment of the invention, the bleach catalyst is a bleach enhancing manganese complex according to the following formula (1) or the following formula (2):

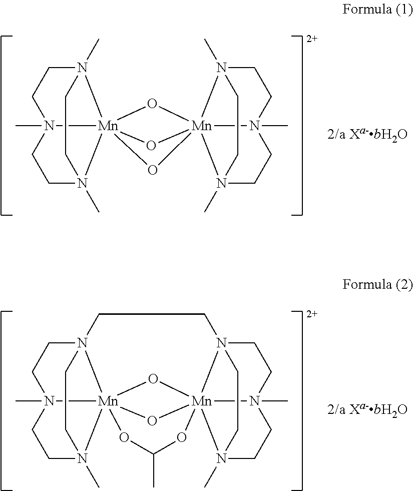

wherein a is 1 or 2; b is a number from 0 to 4; and X is any monovalent or divalent anion, preferably the anion is PF₆⁻, CH₃COO⁻, CI, SO₄²⁻, and in particular PF₆⁻.

Most particularly preferred bleach catalyst particles contain as bleach catalyst bis (N,N′,N″-trimethyl-1,4,7-triazacyclononane)-trioxo-dimangan (IV) di(hexafluorophosphate) monohydrate, that is available as Peractive® MnTACN.

The bleach catalyst is provided in the form of bleach catalyst particles having at least 80% by weight of the above-mentioned bleach catalyst; preferably having at least 90% by weight, and in particular having 95 to 100% by weight of the above-mentioned bleach catalyst.

The bleach catalyst particles are characterized in that at least 70% by weight of the particles have a particle size in the range from 1 μm to 50 μm, at most 15% by weight of the particles have a particle size of >50 μm (more than 50 μm), and at most 15% by weight of the particles have a particle size of <1 μm (less than 1 μm), wherein the percentages are based on the total amount of the particles.

The determination of particle size according to the invention is obtained by laser diffractometry using the standard ISO13320 (2009).

The particle sizes stated are the sizes of the primary particles. The powders according to the invention may also contain aggregates from the primary particles. The size of these aggregates is typically from 5 μm to 5000 μm.

Preferred bleach catalyst particles are characterized in that at least 90% by weight of the particles have particle sizes in the range from 2 μm to 50 μm, at most 5% by weight of the particles have particle sizes of >50 μm, and at most 5% by weight of the particles have particle sizes of <2 μm, wherein the percentages are based on the total amount of the particles.

In a particularly preferred embodiment, the bleach catalyst particles have a volume average particle size D₅₀ in the range from 5 μm to 25 μm.

D₅₀ means that 50% by volume of the particles are smaller than the specified value for D₅₀. Similarly, D₉₇ means that 97% by volume of the particles are smaller than the specified value for D₉₇. Similarly, D₉₉ and D₁₀ mean that 99 and 10% by volume, respectively, of the particles are smaller than the specified value for D₉₉ and D₁₀, respectively.

In an embodiment, the bleach catalyst particles have a volume average particle size D₉₉ of <50 μm and D₁₀ of <5 μm.

In a preferred embodiment, the bleach catalyst particles have a volume average particle size D₉₇ of <50 μm and D₁₀ <5 μm.

In a more preferred embodiment, the bleach catalyst particles have a volume average particle size D₉₉ of <50 μm and D₁₀<1 μm.

In a most preferred embodiment, the bleach catalyst particles comprise no particles having particle sizes greater than 100 μm and/or no particles having particle sizes of less than 100 nm.

In another embodiment, the bleach catalyst particles have a volume average particle size D₉₇ in the range of 8 μm to 35 μm.

In another particularly preferred embodiment, the bleach catalyst particles have a volume average particle size D₉₇ in the range of 10 μm to 30 μm.

In a yet more particularly preferred embodiment, the bleach catalyst particles have a volume average particle size D₉₇ in the range of 11 μm to 25 μm.

In a yet more particularly preferred embodiment the bleach catalyst particles have a volume average particle size D₉₇ in the range of 12 μm to 20 μm.

The distribution of the particle sizes of the bleach catalyst particles can be monomodal or polymodal, preferably monomodal or bimodal, and particularly monomodal. The distribution can be symmetrical or asymmetrical.

The bleach catalyst particles may be produced by the steps of:
(a) introducing a particulate material, comprising at least 80% by weight of a bleach catalyst manganese complex with nitrogen-containing ligands (as described above), into a milling apparatus selected from the group consisting of a jet mill, a pin mill equipped with a cooling device, and a wet mill, wherein the milling apparatus is equipped with a particle separation device (such as a sieve or a cyclone),
(b) grinding the particulate material into a finely divided powder, wherein the temperature of the particulate material during the grinding does not exceed 95° C.; preferably the temperature of the ground material during the grinding is −15° C. to 95° C., preferably <70° C., more preferably <60° C., and most preferably <50° C.

A particularly preferred milling device is the wet mill.

In an embodiment, the grinding of step (b) is carried out so that at least 70% by weight of the total amount of particles of the finely divided powder have particle sizes in the range from 1 μm to 50 μm, at most 15% by weight of the particles have particle sizes of >50 μm, and at most 15% by weight of the particles have particle sizes of <1 μm.

In an embodiment, the coarse particles separated in the particle separation device are led back into the milling apparatus.

In another embodiment, the manganese complex containing particulate material is ground in wet state.

### Detergent Composition

The granule of the invention may be used in a detergent formulated for use in laundry wash or dishwash. The detergent composition comprises a bleaching system, typically in an amount of 1-30% by weight, e.g. 5-20%.

The bleaching system comprises a source of hydrogen peroxide such as sodium percarbonate, sodium perborates and hydrogen peroxide—urea (1:1), preformed peracids and mixtures thereof. Suitable preformed peracids include, but are not limited to, peroxycarboxylic acids and salts, diperoxydicarboxylic acids, perimidic acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono-or tetra-hydrate), percarbonate, persulfate, perphosphate, persilicate salts, in combination with a peracid-forming bleach activator.

The bleaching system may also comprise a bleach activator, i.e. a compound which reacts with hydrogen peroxide to form a peracid via perhydrolysis. The peracid thus formed constitutes the activated bleach. Suitable bleach activators to be used herein include those belonging to the class of esters, amides, imides or anhydrides. Suitable examples are tetraacetylethylenediamine (TAED), sodium 4-[(3,5,5-trimethylhexanoyl)oxy]benzene-1-sulfonate (ISONOBS), 4-(dodecanoyloxy)benzene-1-sulfonate (LOBS), 4-(decanoyloxy)benzene-1-sulfonate, 4-(decanoyloxy)benzoate (DOBS or DOBA), 4-(nonanoyloxy)benzene-1-sulfonate (NOBS), and/or those disclosed in WO98/17767.

The dish wash detergent generally comprises a builder, typically in an amount of 40-65%, particularly 50-65%. The builder may particularly be a chelating agent that forms water-soluble complexes with Ca and Mg. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl) inulin (CMI), and combinations thereof.

Other examples of typical ingredients in dishwash detergent compositions are well-known to a person skilled in the art, and shown in the paragraphs below.

### Surfactants

The dish washing composition can include at least one non-ionic surfactant. Suitable nonionic surfactants include, but are not limited to low-foaming nonionic (LFNI) surfactants. A LFNI surfactant is most typically used in an automatic dishwashing composition because of the improved water-sheeting action (especially from glassware) which they confer to the automatic dishwashing composition. They also may encompass non-silicone, phosphate or non-phosphate polymeric materials which are known to defoam food soils encountered in automatic dishwashing. The LFNI surfactant may have a relatively low cloud point and a high hydrophilic-lipophilic balance (HLB). Cloud points of 1% solutions in water are typically below about 32° C. and alternatively lower, e.g., 0° C., for optimum control of sudsing throughout a full range of water temperatures. If desired, a biodegradable LFNI surfactant having the above properties may be used.

A LFNI surfactant may include, but is not limited to: alkoxylated surfactants, especially ethoxylates derived from primary alcohols, and blends thereof with more sophisticated surfactants, such as the polyoxypropylene/polyoxyethylene/polyoxypropylene reverse block polymers. Suitable block polyoxyethylene-polyoxypropylene polymeric compounds that meet the requirements may include those based on ethylene glycol, propylene glycol, glycerol, trimethylolpropane and ethylenediamine, and mixtures thereof. Polymeric compounds made from a sequential ethoxylation and propoxylation of initiator compounds with a single reactive hydrogen atom, such as C₁₂₋₁₈ aliphatic alcohols, do not generally provide satisfactory suds control in Automatic dishwashing compositions. However, certain of the block polymer surfactant compounds designated as Pluronic™ and Tetronic™ are suitable in automatic dishwashing compositions.

The LFNI surfactant can optionally include a propylene oxide in an amount up to about 15% by weight. Other LFNI surfactants can be prepared by the processes described in U.S. Pat. No. 4,223,163. The LFNI surfactant may also be derived from a straight chain fatty alcohol containing from about 16 to about 20 carbon atoms (C₁₆-C₂₀ alcohol), alternatively a C₁₈ alcohol, condensed with an average of from about 6 to about 15 moles, or from about 7 to about 12 moles, and alternatively, from about 7 to about 9 moles of ethylene oxide per mole of alcohol. The ethoxylated nonionic surfactant so derived may have a narrow ethoxylate distribution relative to the average.

In certain embodiments, a LFNI surfactant having a cloud point below 30° C. may be present in an amount from about 0.01% to about 60%, or from about 0.5% to about 10% by weight, and alternatively, from about 1% to about 5% by weight of the composition.

In preferred embodiments, the surfactant is a non-ionic surfactant or a non-ionic surfactant system having a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and stability in product than single non-ionic surfactants.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Other suitable non-ionic surfactants are epoxy-capped poly(oxyalkylated) alcohols represented by the formula:

R₁O[CH₂CH(CH₃)O]ₓ[CH₂CH₂O]_{y}[CH₂CH(OH)R₂] (I)

wherein R₁ is a linear or branched, aliphatic hydrocarbon radical having from 4 to 18 carbon atoms; R₂ is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20. Preferably, such surfactants have at least about 10 carbon atoms in the terminal epoxide unit [CH₂CH(OH)R₂]. Suitable examples are described in WO 94/22800.

Preferably non-ionic surfactants have a Draves wetting time of less than 360 seconds, preferably less than 200 seconds, more preferably less than 100 seconds and especially less than 60 seconds as measured by the Draves wetting method (standard method ISO 8022 using the following conditions; 3-g hook, 5-g cotton skein, 0.1% by weight aqueous solution at a temperature of 25° C.).

Amine oxides surfactants are also useful in the present invention as anti-redeposition surfactants include linear and branched compounds having the formula:

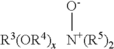

wherein R³ is selected from an alkyl, hydroxyalkyl, acylamidopropoyl and alkyl phenyl group, or mixtures thereof, containing from 8 to 26 carbon atoms, preferably 8 to 18 carbon atoms; R⁴ is an alkylene or hydroxyalkylene group containing from 2 to 3 carbon atoms, preferably 2 carbon atoms, or mixtures thereof; x is from 0 to 5, preferably from 0 to 3; and each R⁵ is an alkyl or hydroxyalkyl group containing from 1 to 3, preferably from 1 to 2 carbon atoms, or a polyethylene oxide group containing from 1 to 3, preferable 1, ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₈ alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C₁₀-C₁₈ alkyl dimethylamine oxide, and C₁₀-C₁₈ acylamido alkyl dimethylamine oxide. Surfactants and especially non-ionic surfactants may be present in amounts from 0 to 10% by weight, preferably from 0.1% to 10%, and most preferably from 0.25% to 6%.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-10% by weight, for example 0-5% by weight, such as about 0.5 to about 5%, or about 3% to about 5%, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65% by weight, such as about 5% to about 50% of a detergent builder or co-builder, or a mixture thereof. In a dish wash detergent, the level of builder is typically 40-65%, particularly 50-65%. The builder and/or co-builder may particularly be a chelating agent that forms water-soluble complexes with Ca and Mg. Any builder and/or co-builder known in the art for use in ADW detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl) inulin (CMI), and combinations thereof.

The detergent composition may also contain 0-50% by weight, such as about 5% to about 30%, of a detergent co-builder. The detergent composition may include include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra(methylenephosphonic acid) (EDTMPA), diethylenetriaminepentakis(methylenephosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

### Bleaching Systems

Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate are preferred perhydrates for use herein. The percarbonate is most preferably incorporated into the products in a coated form which provides in-product stability. A suitable coating material providing in product stability comprises mixed salt of a water-soluble alkali metal sulphate and carbonate. Such coatings together with coating processes have previously been described in GB 1,466,799. The weight ratio of the mixed salt coating material to percarbonate lies in the range from 1:200 to 1:4, more preferably from 1:99 to 1:19, and most preferably from 1:49 to 1:19. Preferably, the mixed salt is of sodium sulphate and sodium carbonate which has the general formula Na2SO4.n.Na2CO3 wherein n is from 0.1 to 3, preferably n is from 0.3 to 1.0 and most preferably n is from 0.2 to 0.5.

Another suitable coating material providing in product stability, comprises sodium silicate of SiO2:Na2O ratio from 1.8: 1 to 3.0: 1, preferably 1.8: 1 to 2.4: 1, and/or sodium metasilicate, preferably applied at a level of from 2% to 10%, (normally from 3% to 5%) of SiO2 by weight of the inorganic perhydrate salt. Magnesium silicate can also be included in the coating. Coatings that contain silicate and borate salts or boric acids or other inorganics are also suitable.

Other coatings which contain waxes, oils, fatty soaps can also be used advantageously within the present invention.

Potassium peroxymonopersulfate is another inorganic perhydrate salt of utility herein. Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. Mono- and diperazelaic acid, mono- and diperbrassylic acid, and Nphthaloylaminoperoxicaproic acid are also suitable herein. The diacyl peroxide, especially dibenzoyl peroxide, should preferably be present in the form of particles having a weight average diameter of from about 0.1 to about 100 microns, preferably from about 0.5 to about 30 microns, more preferably from about 1 to about 10 microns. Preferably, at least about 25%, more preferably at least about 50%, even more preferably at least about 75%, most preferably at least about 90%, of the particles are smaller than 10 microns, preferably smaller than 6 microns. Diacyl peroxides within the above particle size range have also been found to provide better stain removal especially from plastic dishware, while minimizing undesirable deposition and filming during use in automatic dishwashing machines, than larger diacyl peroxide particles. The preferred diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process.

Further typical organic bleaches include the peroxy acids, particular examples being the alkylperoxy acids and the arylperoxy acids. Preferred representatives are (a) peroxybenzoic acid and its ring-substituted derivatives, such as alkylperoxybenzoic acids, but also peroxy-[alpha]-naphthoic acid and magnesium monoperphthalate, (b) the aliphatic or substituted aliphatic peroxy acids, such as peroxylauric acid, peroxystearic acid, [epsilon]-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-l,4-dioic acid, N,N-terephthaloyldi(6-aminopercaproic acid).

### Bleach Activators

Bleach activators are typically organic peracid precursors that enhance the bleaching action in the course of cleaning at temperatures of 60[deg.] C. and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular l,5-diacetyl-2,4-dioxohexahydro-l,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso- NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.1 to about 10%, preferably from about 0.5 to about 2% by weight of the composition.

### Silicates

Preferred silicates are sodium silicates such as sodium disilicate, sodium metasilicate and crystalline phyllosilicates. Silicates if present are at a level of from about 1 to about 20%, preferably from about 5 to about 15% by weight of composition.

### Metal Care Agents

Metal care agents may prevent or reduce the tarnishing, corrosion or oxidation of metals, including aluminium, stainless steel and non-ferrous metals, such as silver and copper. Suitable examples include one or more of the following:
(a) benzatriazoles, including benzotriazole or bis-benzotriazole and substituted derivatives thereof. Benzotriazole derivatives are those compounds in which the available substitution sites on the aromatic ring are partially or completely substituted. Suitable substituents include linear or branch-chain C₁-C₂₀-alkyl groups and hydroxyl, thio, phenyl or halogen such as fluorine, chlorine, bromine and iodine.
(b) metal salts and complexes chosen from the group consisting of zinc, manganese, titanium, zirconium, hafnium, vanadium, cobalt, gallium and cerium salts and/or complexes, the metals being in one of the oxidation states II, III, IV, V or VI. In one aspect, suitable metal salts and/or metal complexes may be chosen from the group consisting of Mn(II) sulphate, Mn(II) citrate, Mn(II) stearate, Mn(II) acetylacetonate, K₂TiF₆, K₂ZrF₆, CoSO₄, Co(NO₃)₂ and Ce(NO₃)₃, zinc salts, for example zinc sulphate, hydrozincite or zinc acetate.
(c) silicates, including sodium or potassium silicate, sodium disilicate, sodium metasilicate, crystalline phyllosilicate and mixtures thereof.

Further suitable organic and inorganic redox-active substances that act as silver/copper corrosion inhibitors are disclosed in WO 94/26860 and WO 94/26859.

Preferably the composition of the invention comprises from 0.1 to 5% by weight of the composition of a metal care agent, preferably the metal care agent is a zinc salt.

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl) cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

### Enzymes

The detergent additive as well as the detergent composition may comprise one or more enzymes, in particular enzymes suitable for including in laundry or dishwash detergents (detergent enzymes), such as a protease (e.g., subtilisin or metalloprotease), lipase, cutinase, amylase, carbohydrase, cellulase, pectinase, mannanase, arabinase, galactanase, xanthanase, xylanase, DNAse, perhydrolase, oxidoreductase (e.g., laccase, peroxidase, peroxygenase and/or haloperoxidase).

Preferred detergent enzymes are protease (e.g., subtilisin or metalloprotease), lipase, amylase, lyase, cellulase, pectinase, mannanase, DNAse, perhydrolase, and oxidoreductases (e.g., laccase, peroxidase, peroxygenase and/or haloperoxidase); or combinations thereof.

Particularly preferred detergent enzymes are protease (e.g., subtilisin or metalloprotease), lipase, amylase, cellulase, pectinase, and mannanase; or combinations thereof.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

### Proteases

The proteases for use in the present invention are serine proteases, such as subtilisins, metalloproteases and/or trypsin-like proteases. Preferably, the proteases are subtilisins or metalloproteases; more preferably, the proteases are subtilisins.

A serine protease is an enzyme which catalyzes the hydrolysis of peptide bonds, and in which there is an essential serine residue at the active site (White, Handler and Smith, 1973 “Principles of Biochemistry,” Fifth Edition, McGraw-Hill Book Company, NY, pp. 271-272). Subtilisins include, preferably consist of, the I-S1 and I-S2 sub-groups as defined by Siezen et al., Protein Engng. 4 (1991) 719-737; and Siezen et al., Protein Science 6 (1997) 501-523. Because of the highly conserved structure of the active site of serine proteases, the subtilisin according to the invention may be functionally equivalent to the proposed sub-group designated subtilase by Siezen et al. (supra).

The subtilisin may be of animal, vegetable or microbial origin, including chemically or genetically modified mutants (protein engineered variants), preferably an alkaline microbial subtilisin. Examples of subtilisins are those derived from Bacillus, e.g., subtilisin Novo, subtilisin Carlsberg, subtilisin BPN′, subtilisin 309, subtilisin 147 and subtilisin 168 (described in WO 89/06279) and Protease PD138 (WO 93/18140). Examples are described in WO 98/020115, WO 01/44452, WO 01/58275, WO 01/58276, WO 03/006602 and WO 04/099401.

Other examples of useful proteases are the variants described in WO92/19729, WO96/034946, WO98/20115, WO98/20116, WO99/011768, WO01/44452, WO03/006602, WO04/03186, WO04/041979, WO07/006305, WO11/036263, WO11/036264, especially the variants with substitutions in one or more of the following positions: 3, 4, 9, 15, 27, 36, 43, 57, 61, 62, 68, 76, 87, 95, 96, 97, 98, 99, 100, 101, 102, 103, 104, 106, 118, 120, 123, 128, 129, 130, 156, 158, 160, 161, 167, 170, 182, 185, 188, 191, 194, 195, 199, 204, 205, 206, 209, 212, 217, 218, 224, 232, 235, 236, 245, 248, 252, 261, 262, 274 and 275, using the BPN′ numbering. The protease may comprise a substitution at one or more positions corresponding to positions 171, 173, 175, 179, or 180 of SEQ ID NO: 3 of WO 2004/067737.

More preferred the protease variants may comprise one or more of the following substitutions: S3T, V4I, S9R, S9E, A15T, K27R, *36D, N43R, G61E, G61D, N62D, N62E, V68A, N76D, N87S,R, *97E, A98S, S99G,S99D, S99A, S99AD, S101E, S101D, S101G, S101M, S101N, S101R, S101H, S103A, V104I, V104Y, V104N, S106A, G118V, G118R, H120D, H120N, N123S, S128L, P129Q, S130A, S156D, A158E, G160D, G160P, S161E, Y167A, R170S, Q182E, N185E, S188E, Q191N, A194P, G195E, V199M, N204D, V205I, Y209W, S212G, L217Q, L217D, N218D, N218S, A232V, K235L, Q236H, Q245R, N252K, N261W, N261D, N261E, L262E, L262D T274A, R275H (using BPN′ numbering).

Examples of commercially available proteases include those sold under the trade names Alcalase™, Relase™, Relase™ Ultra, Savinase™, Savinase™ Ultra, Duralase™, Durazym™, Everlase™, Primase™, Polarzyme™, Kannase™, Liquanase™, Liquanase™ Ultra, Ovozyme™, Coronase™, Coronase™ Ultra, Blaze™, Blaze Evity™ 100T, Blaze Evity™ 125T, Blaze Evity™ 150T, Neutrase™, and Esperase™ (Novozymes A/S); those sold under the tradename Maxatase™, Maxacal™, Puramax™, FN2™, FN3™, FN4™, Excellase™, Maxapem™, Purafect Ox™, Purafect OxP™, Effectenz™ P1050, Effectenz™ P1060, Excellenz™ P1000, Excellenz™ P1250, Eraser™, Preferenz™ P100, Purafect Prime™, Preferenz™ P110, Effectenz™ P1000, Purafect™, Effectenz™ P2000, Purafast™, Properase™, Opticlean™ and Optimase™ (Genencor/Danisco/DuPont); Axapem™ (Gist-Brocases N.V.); BLAP (sequence shown in FIG. 29 of U.S. Pat. No. 5,352,604) and variants hereof (Henkel AG); and KAP (Bacillus alkalophilus subtilisin) from Kao.

### Lyases

The lyase may be a pectate lyase derived from Bacillus, particularly B. licherniformis or B. agaradhaerens, or a variant derived of any of these, e.g. as described in U.S. Pat. No. 6,124,127, WO 99/027083, WO 99/027084, WO 02/006442, WO 02/092741, WO 03/095638, Commercially available pectate lyases are XPect™; Pectawash™ and Pectaway™ (Novozymes A/S).

### Mannanase

The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 99/064619. Commercially available mannanases are Mannaway™ (Novozymes A/S), and Mannastar™ (Dupont).

### Cellulases

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO 89/09259.

Especially suitable cellulases are the alkaline or neutral cellulases having color care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307 and PCT/DK98/00299.

Commercially available cellulases include Celluzyme™, Carezyme™, Carezyme Premium™, Whitezyme™, and Celluclean™ (Novozymes A/S); Clazinase™, Revitalenz™, and Puradax HA™ (DuPont); Biotouch™ DCL and FCL (AB Enzymes); and KAC-500(B)™ (Kao Corporation).

### Lipases and Cutinases

Suitable lipases and cutinases include those of bacterial or fungal origin. Chemically modified or protein engineered mutants are included. Examples include lipase from Thermomyces, e.g., from T. lanuginosus (previously named Humicola lanuginosa) as described in EP 258 068 and EP 305 216, cutinase from Humicola, e.g., H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al., 1993, Biochemica et Biophysica Acta, 1131:253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079, WO 97/07202, WO 00/060063, WO 2007/087508 and WO 2009/109500.

Preferred commercially available lipase enzymes include Lipolase™, Lipolase Ultra™, and Lipex™; Lecitase™, Lipolex™; Lipoclean™, Lipoprime™ (Novozymes A/S). Other commercially available lipases include Lumafast (DuPont); Lipomax (Gist-Brocades/DuPont) and Bacillus sp. lipase from Solvay.

### Amylases

Suitable amylases (α and/or α) include those of bacterial or fungal origin. Chemically modified or protein engineered mutants are included. Amylases include, for example, α amylases obtained from Bacillus, e.g., a special strain of Bacillus licheniformis, described in more detail in GB 1,296,839.

Examples of suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193. Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, I201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:
M197T;
H156Y+A181T+N190F+A209V+Q264S; or
G48A+T49I+G107A+H156Y+A181T+N190F+I201F+A209V+Q264S.

Further amylases which are suitable are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, I206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/023873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476. More preferred variants are those having a deletion in positions 181 and 182 or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 09/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:
N128C+K178L+T182G+Y305R+G475K;
N128C+K178L+T182G+F202Y+Y305R+D319T+G475K;
S125A+N128C+K178L+T182G+Y305R+G475K; or
S125A+N128C+T131I+T165I+K178L+T182G+Y305R+G475K wherein the variants are C-terminally truncated and optionally further comprises a substitution at position 243 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Stainzyme™; Stainzyme Plus™; Duramyl™, Termamyl™, Termamyl Ultra™; Natalase™, Fungamyl™ and BAN™ (Novozymes A/S), Rapidase™ and Purastar™/Effectenz™, Powerase™, Amplify™, Amplify Prime™, Preferenz™ S100, and Preferenz™ S110 (DuPont).

### Deoxyribonuclease (DNase)

Suitable deoxyribonucleases (DNases) are any enzyme that catalyzes the hydrolytic cleavage of phosphodiester linkages in the DNA backbone, thus degrading DNA. According to the invention, a DNase which is obtainable from a bacterium is preferred; in particular a DNase which is obtainable from a Bacillus is preferred; in particular a DNase which is obtainable from Bacillus subtilis or Bacillus licheniformis is preferred. Examples of such DNases are described in patent application WO 2011/098579 or in PCT/EP2013/075922.

### Perhydrolases

Suitable perhydrolases are capable of catalyzing a perhydrolysis reaction that results in the production of a peracid from a carboxylic acid ester (acyl) substrate in the presence of a source of peroxygen (e.g., hydrogen peroxide). While many enzymes perform this reaction at low levels, perhydrolases exhibit a high perhydrolysis: hydrolysis ratio, often greater than 1. Suitable perhydrolases may be of plant, bacterial or fungal origin. Chemically modified or protein engineered mutants are included.

Examples of useful perhydrolases include naturally occurring Mycobacterium perhydrolase enzymes, or variants thereof. An exemplary enzyme is derived from Mycobacterium smegmatis. Such enzyme, its enzymatic properties, its structure, and variants thereof, are described in WO 2005/056782, WO 2008/063400, US 2008/145353, and US2007167344.

### Oxidases/Peroxidases

Suitable oxidases and peroxidases (or oxidoreductases) include various sugar oxidases, laccases, peroxidases and haloperoxidases.

Suitable peroxidases include those comprised by the enzyme classification EC 1.11.1.7, as set out by the Nomenclature Committee of the International Union of Biochemistry and Molecular Biology (IUBMB), or any fragment derived therefrom, exhibiting peroxidase activity.

Suitable peroxidases include those of plant, bacterial or fungal origin. Chemically modified or protein engineered mutants are included. Examples of useful peroxidases include peroxidases from Coprinopsis, e.g., from C. cinerea (EP 179,486), and variants thereof as those described in WO 93/24618, WO 95/10602, and WO 98/15257.

A peroxidase for use in the invention also include a haloperoxidase enzyme, such as chloroperoxidase, bromoperoxidase and compounds exhibiting chloroperoxidase or bromoperoxidase activity. Haloperoxidases are classified according to their specificity for halide ions. Chloroperoxidases (E.C. 1.11.1.10) catalyze formation of hypochlorite from chloride ions.

In an embodiment, the haloperoxidase is a chloroperoxidase. Preferably, the haloperoxidase is a vanadium haloperoxidase, i.e., a vanadate-containing haloperoxidase. In a preferred method of the present invention the vanadate-containing haloperoxidase is combined with a source of chloride ion.

Haloperoxidases have been isolated from many different fungi, in particular from the fungus group Dematiaceous hyphomycetes, such as Caldariomyces, e.g., C. fumago, Alternaria, Curvularia, e.g., C. verruculosa and C. inaequalis, Drechslera, Ulocladium and Botrytis.

Haloperoxidases have also been isolated from bacteria such as Pseudomonas, e.g., P. pyrrocinia and Streptomyces, e.g., S. aureofaciens.

In an preferred embodiment, the haloperoxidase is derivable from Curvularia sp., in particular Curvularia verruculosa or Curvularia inaequalis, such as C. inaequalis CBS 102.42 as described in WO 95/27046; or C. verruculosa CBS 147.63 or C. verruculosa CBS 444.70 as described in WO 97/04102; or from Drechslera hartlebii as described in WO 01/79459, Dendryphiella salina as described in WO 01/79458, Phaeotrichoconis crotalarie as described in WO 01/79461, or Geniculosporium sp. as described in WO 01/79460.

An oxidase according to the invention include, in particular, any laccase enzyme comprised by the enzyme classification EC 1.10.3.2, or any fragment derived therefrom exhibiting laccase activity, or a compound exhibiting a similar activity, such as a catechol oxidase (EC 1.10.3.1), an o-aminophenol oxidase (EC 1.10.3.4), or a bilirubin oxidase (EC 1.3.3.5).

Preferred laccase enzymes are enzymes of microbial origin. The enzymes may be derived from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinopsis, e.g., C. cinerea, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radiata (WO 92/01046), or Coriolus, e.g., C. hirsutus (JP 2238885).

Suitable examples from bacteria include a laccase derivable from a strain of Bacillus.

A laccase derived from Coprinopsis or Myceliophthora is preferred; in particular a laccase derived from Coprinopsis cinerea, as disclosed in WO 97/08325; or from Myceliophthora thermophila, as disclosed in WO 95/33836.

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries.

Non-dusting granulates may be produced, e.g. as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

### Adjunct Materials

Any detergent components known in the art for use in ADW detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, peptide aldehydes and bisulfites thereof, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use ADW detergents may be utilized. The choice of such ingredients is well within the skill of the artisan.

### Dispersants

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

### Dye Transfer Inhibiting Agents

The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

### Fluorescent Whitening Agent

The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino) stilbene-2,2′-disulfonate, 4,4′-bis-(2,4-dianilino-s-triazin-6-ylamino) stilbene-2.2′-disulfonate, 4,4′-bis-(2-anilino-4-(N-methyl-N-2-hydroxy-ethylamino)-s-triazin-6-ylamino) stilbene-2,2′-disulfonate, 4,4′-bis-(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino) stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

### Soil Release Polymers

The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

### Anti-Redeposition Agents

The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

### Rheology Modifiers

The detergent compositions of the present invention may also include one or more rheology modifiers, structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent.

The invention includes the following particularly preferred embodiments:

Embodiment 1. A non-enzymatic granule comprising
(a) a core, surrounded by
(b) a first coating which comprises bleach catalyst particles and a binder, which is surrounded by
(c) a second coating comprising at least 60% by weight of the coating of a water-soluble salt having a constant humidity at 20° C. which is above 85%, which is surrounded by
(d) a third coating;
   wherein the bleach catalyst particles comprise at least 80% by weight of a manganese complex with nitrogen-containing ligands; wherein at least 70% by weight of the particles have particle sizes in the range from 1 μm to 50 μm, at most 15% by weight of the particles have particle sizes of >50 μm and at most 15% by weight of the particles have particle sizes of <1 μm, wherein the percentages are based on the total amount of the particles.

Embodiment 2. The granule of embodiment 1, wherein the manganese complex comprises a ligand which is di- or trimethyl azacyclononane or a derivative thereof.

Embodiment 3. The granule of embodiment 1 or 2, wherein the manganese complex has the below formula (1) or (2):

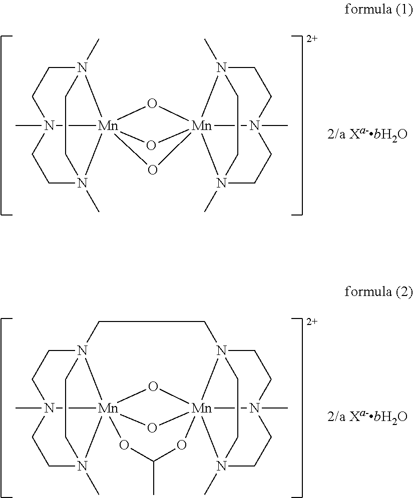

wherein a is 1 or 2, b is a number from 0 to 4, and X is any monovalent or divalent anion.

Embodiment 4. The granule of embodiment 3, wherein X is PF₆⁻, CH₃COO⁻, Cl⁻, SO₄²⁻, and in particular PF₆⁻.

Embodiment 5. The granule of any one of embodiments 1 to 4, wherein the manganese complex is bis (N,N′,N″-trimethyl-1,4,7-triazacyclononane)-trioxo-dimanganese (IV) di(hexafluorophosphate) monohydrate.

Embodiment 6. The granule of any one of embodiments 1 to 5, wherein the bleach catalyst particles comprises no particles having particle sizes greater than 100 μm and/or no particles having particle sizes of less than 100 nm.

Embodiment 7. The granule of any one of embodiments 1 to 6, wherein at least 90% by weight of the bleach catalyst particles have particle sizes in the range from 2 μm to 50 μm, at most 5% by weight of the particles have particle sizes of >50 μm, and at most 5% by weight of the particles have particle sizes of <2 μm, wherein the percentages are based on the total amount of the particles.

Embodiment 8. The granule of any one of embodiments 1 to 7, wherein the bleach catalyst particles have a volume average particle size D₅₀ in the range of 5 to 25 μm.

Embodiment 9. The granule of any one of embodiments 1 to 8, wherein the bleach catalyst particles have a volume average particle size D₉₇ in the range of 8 μm to 35 μm.

Embodiment 10. The granule of any one of embodiments 1 to 9, wherein the bleach catalyst particles have a volume average particle size D₉₇ in the range of 10 μm to 30 μm.

Embodiment 11. The granule of any one of embodiments 1 to 10, wherein the bleach catalyst particles have a volume average particle size D₉₇ in the range of 11 μm to 25 μm.

Embodiment 12. The granule of any one of embodiments 1 to 11, wherein the bleach catalyst particles have a volume average particle size D₉₇ in the range of 12 μm to 20 μm.

Embodiment 13. The granule of any one of embodiments 1 to 12, wherein the bleach catalyst particles are produced by the steps of:
(a) introducing a particulate material, comprising at least 80% by weight of manganese complexes with nitrogen-containing ligands, into a milling apparatus selected from the group consisting of a jet mill, a pin mill equipped with a cooling device, and a wet mill, wherein the milling apparatus is equipped with a particle separation device (such as a sieve or a cyclone),
(b) grinding the particulate material into a finely divided powder, wherein the temperature of the particulate material during the grinding does not exceed 95° C.

Embodiment 14. The granule of embodiment 13, wherein the temperature of the ground material during the grinding is −15° C. to 95° C., preferably <70° C., more preferably <60° C., and most preferably <50° C.

Embodiment 15. The granule of embodiment 13 or 14, wherein the coarse particles separated in the particle separation device are led back into the milling apparatus.

Embodiment 16. The granule of any one of embodiments 13 to 15, wherein the manganese complex containing particulate material is ground in wet state.

Embodiment 17. The granule of any one of embodiments 1 to 16, wherein the core comprises a reducing agent and/or an antioxidant and/or a salt of a multivalent cation and/or an acidic buffer.

Embodiment 18. The granule of embodiment 17, wherein the reducing agent is a thiosulfate, cysteine or methionine.

Embodiment 19. The granule of embodiment 17 or 18, wherein the reducing agent is present in an amount of 0.1-10% by weight relative to the core.

Embodiment 20. The granule of any one of embodiments 17 to 19, wherein the acidic buffer comprises a mixture of citric acid and a citrate.

Embodiment 21. The granule of any one of embodiments 17 to 20, wherein the acidic buffer is present in an amount of 0.1 to 10% by weight relative to the core.

Embodiment 22. The granule of any one of embodiments 17 to 21, wherein the salt of a multivalent cation is a salt of Mg or Zn.

Embodiment 23. The granule of any one of embodiments 17 to 22, wherein the salt of a multivalent cation is present in an amount of 0.1 to 15% as anhydrous salt by weight of the core, or 0.02-6% as multivalent cation by weight of the core.

Embodiment 24. The granule of any one of embodiments 1 to 23, wherein the average thickness of the first coating is in the range of 1 to 15 μm.

Embodiment 25. The granule of any one of embodiments 1 to 24, wherein the average thickness of the first coating is in the range of 1 to 10 μm.

Embodiment 26. The granule of any one of embodiments 1 to 25, wherein the average total thickness of the second and third coating is at least 400% of the thickness of the first coating.

Embodiment 27. The granule of any one of embodiments 1 to 26, wherein the average total thickness of the second and third coating is at least 20 μm.

Embodiment 28. The granule of any one of embodiments 1 to 27, wherein the average total thickness of the second and third coating is at least 30 μm.

Embodiment 29. The granule of any one of embodiments 1 to 28, wherein the amount of bleach catalyst in the first coating is in the range of 2 to 15% by weight of the core.

Embodiment 30. The granule of any one of embodiments 1 to 29, wherein the amount of bleach catalyst in the first coating is in the range of 3 to 10% by weight of the core.

Embodiment 31. The granule of any one of embodiments 1 to 30, wherein the amount of binder in the first coating is in the range of 1 to 20% by weight of the core.

Embodiment 32. The granule of any one of embodiments 1 to 31, wherein the amount of binder in the first coating is in the range of 1 to 15% by weight of the core.

Embodiment 33. The granule of any one of embodiments 1 to 32, wherein the binder comprises a carbohydrate.

Embodiment 34. The granule of any one of embodiments 1 to 33, wherein the binder comprises dextrin.

Embodiment 35. The granule of any one of embodiments 1 to 34, wherein the combined second and third coating makes up at least 30% by weight of the core.

Embodiment 36. The granule of any one of embodiments 1 to 35, wherein the combined second and third coating makes up at least 40% by weight of the core.

Embodiment 37. The granule of any one of embodiments 1 to 36, wherein the second coating makes up 20 to 100% by weight of the core.

Embodiment 38. The granule of any one of embodiments 1 to 37, wherein the second coating makes up 30 to 80% by weight of the core.

Embodiment 39. The granule of any one of embodiments 1 to 38, wherein the second coating comprises at least 80% by weight w/w of a salt having a constant humidity at 20° C. of at least 85%.

Embodiment 40. The granule of any one of embodiments 1 to 39, wherein the second coating comprises at least 90% by weight w/w of a salt having a constant humidity at 20° C. of at least 85%.

Embodiment 41. The granule of any one of embodiments 1 to 40, wherein the second coating comprises sodium sulfate.

Embodiment 42. The granule of any one of embodiments 1 to 41, wherein the third coating makes up 0.5 to 20% by weight of the core.

Embodiment 43. The granule of any one of embodiments 1 to 42, wherein the third coating makes up 0.5 to 10% by weight of the core.

Embodiment 44. The granule of any one of embodiments 1 to 43, wherein the third coating makes up 1 to 10% by weight of the core.

Embodiment 45. The granule of any one of embodiments 1 to 44, wherein the third coating makes up 1 to 10% by weight of the core.

Embodiment 46. The granule of any one of embodiments 1 to 45, wherein the third coating comprises a film-forming agent.

Embodiment 47. The granule of embodiment 46, wherein the film-forming agent is a film-forming polymer.

Embodiment 48. The granule of embodiment 46 or 47, wherein the film-forming agent is polyethylene glycol, hydroxypropyl methyl cellulose (HPMC or MHPC), or polyvinyl alcohol (PVA).

Embodiment 49. A detergent composition which comprises a surfactant, a detergent builder, a bleaching agent which is a H₂O₂ source/precursor (such as percarbonate), an enzyme, and which detergent composition further comprises a granule according to any one of embodiments 1 to 48.

Embodiment 50. The composition of embodiment 49, which further comprises a bleach activator.

Embodiment 51. The composition of embodiment 49 or 50, which is a laundry detergent.

Embodiment 52. The composition of embodiment 49 or 50, which is a dishwash detergent.

Embodiment 53. The composition of any one of embodiments 49 to 52, which is a liquid or gel detergent.

Embodiment 54. The composition of any one of embodiments 49 to 52, which is a particulate detergent.

Embodiment 55. A method for producing a non-enzymatic granule, preferably the granule of any one of embodiments 1 to 48, comprising
(a) preparing a core,
(b) surrounding the core with a first coating which comprises bleach catalyst particles and a binder,
(c) surrounding the first coating with a second coating comprising at least 60% by weight of a water-soluble salt having a constant humidity at 20° C. which is above 85%, and
(d) surrounding the second coating with a third coating;
   wherein the bleach catalyst particles comprise at least 80% by weight of a manganese complex with nitrogen-containing ligands; wherein at least 70% by weight of the particles have particle sizes in the range from 1 μm to 50 μm, at most 15% by weight of the particles have particle sizes of >50 μm and at most 15% by weight of the particles have particle sizes of <1 μm, wherein the percentages are based on the total amount of the particles.

Embodiment 56. The method of embodiment 55, wherein the manganese complex comprises a ligand which is di- or trimethyl azacyclononane or a derivative thereof.

Embodiment 57. The method of embodiment 55 or 56, wherein the manganese complex has the below formula (1) or (2):

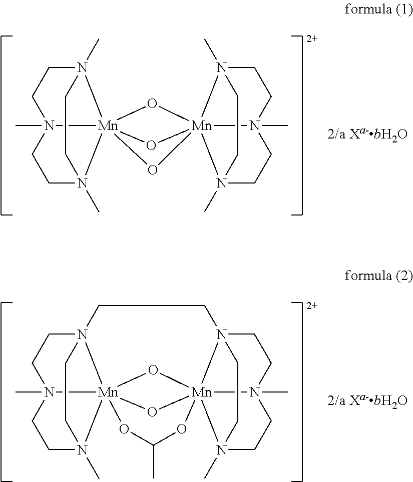

wherein a is 1 or 2, b is a number from 0 to 4, and X is any monovalent or divalent anion.

Embodiment 58. The method of embodiment 57, wherein X is PF₆⁻, CH₃COO⁻, Cl⁻, SO₄²⁻, and in particular PF₆⁻.

Embodiment 59. The method of any one of embodiments 55 to 58, wherein the manganese complex is bis (N,N′,N″-trimethyl-1,4,7-triazacyclononane)-trioxo-dimanganese (IV) di(hexafluorophosphate) monohydrate.

Embodiment 60. The method of any one of embodiments 55 to 59, wherein the bleach catalyst particles comprises no particles having particle sizes greater than 100 μm and/or no particles having particle sizes of less than 100 nm.

Embodiment 61. The method of any one of embodiments 55 to 60, wherein at least 90% by weight of the bleach catalyst particles have particle sizes in the range from 2 μm to 50 μm, at most 5% by weight of the particles have particle sizes of >50 μm, and at most 5% by weight of the particles have particle sizes of <2 μm, wherein the percentages are based on the total amount of the particles.

Embodiment 62. The method of any one of embodiments 55 to 61, wherein the bleach catalyst particles have a volume average particle size D₅₀ in the range of 5 to 25 μm.

Embodiment 63. The method of any one of embodiments 55 to 62, wherein the bleach catalyst particles have a volume average particle size D₉₇ in the range of 8 μm to 35 μm.

Embodiment 64. The method of any one of embodiments 55 to 63, wherein the bleach catalyst particles have a volume average particle size D₉₇ in the range of 10 μm to 30 μm.

Embodiment 65. The method of any one of embodiments 55 to 64, wherein the bleach catalyst particles have a volume average particle size D₉₇ in the range of 11 μm to 25 μm.

Embodiment 66. The method of any one of embodiments 55 to 65, wherein the bleach catalyst particles have a volume average particle size D₉₇ in the range of 12 μm to 20 μm.

Embodiment 67. The method of any one of embodiments 55 to 66, wherein the bleach catalyst particles are produced by the steps of:
(a) introducing a particulate material, comprising at least 80% by weight of manganese complexes with nitrogen-containing ligands, into a milling apparatus selected from the group consisting of a jet mill, a pin mill equipped with a cooling device, and a wet mill, wherein the milling apparatus is equipped with a particle separation device (such as a sieve or a cyclone),
(b) grinding the particulate material into a finely divided powder, wherein the temperature of the particulate material during the grinding does not exceed 95° C.

Embodiment 68. The method of embodiment 67, wherein the temperature of the ground material during the grinding is −15° C. to 95° C., preferably <70° C., more preferably <60° C., and most preferably <50° C.

Embodiment 69. The method of embodiment 67 or 68, wherein the coarse particles separated in the particle separation device are led back into the milling apparatus.

Embodiment 70. The method of any one of embodiments 67 to 69, wherein the manganese complex containing particulate material is ground in wet state.

Embodiment 71. The method of any one of embodiments 55 to 70, wherein the core comprises a reducing agent and/or an antioxidant and/or a salt of a multivalent cation and/or an acidic buffer.

Embodiment 72. The method of embodiment 71, wherein the reducing agent is a thiosulfate, cysteine or methionine.

Embodiment 73. The method of embodiment 71 or 72, wherein the reducing agent is present in an amount of 0.1-10% by weight relative to the core.

Embodiment 74. The method of any one of embodiments 71 to 73, wherein the acidic buffer comprises a mixture of citric acid and a citrate.

Embodiment 75. The method of any one of embodiments 71 to 74, wherein the acidic buffer is present in an amount of 0.1-10% by weight relative to the core.

Embodiment 76. The method of any one of embodiments 71 to 75, wherein the salt of a multivalent cation is a salt of Mg or Zn.

Embodiment 77. The method of any one of embodiments 71 to 76, wherein the salt of a multivalent cation is present in an amount of 0.1-15% as anhydrous salt by weight of the core, or 0.02-6% as multivalent cation by weight of the core.

Embodiment 78. The method of any one of embodiments 55 to 77, wherein the average thickness of the first coating is in the range of 1 to 15 μm.

Embodiment 79. The method of any one of embodiments 55 to 78, wherein the average thickness of the first coating is in the range of 1 to 10 μm.

Embodiment 80. The method of any one of embodiments 55 to 79, wherein the average total thickness of the second and third coating is at least 400% of the thickness of the first coating.

Embodiment 81. The method of any one of embodiments 55 to 80, wherein the average total thickness of the second and third coating is at least 20 μm.

Embodiment 82. The method of any one of embodiments 55 to 81, wherein the average total thickness of the second and third coating is at least 30 μm.

Embodiment 83. The method of any one of embodiments 55 to 82, wherein the amount of bleach catalyst in the first coating is in the range of 2 to 15% by weight of the core.

Embodiment 84. The method of any one of embodiments 55 to 83, wherein the amount of bleach catalyst in the first coating is in the range of 3 to 10% by weight of the core.

Embodiment 85. The method of any one of embodiments 55 to 84, wherein the amount of binder in the first coating is in the range of 1 to 20% by weight of the core.

Embodiment 86. The method of any one of embodiments 55 to 85, wherein the amount of binder in the first coating is in the range of 1 to 15% by weight of the core.

Embodiment 87. The method of any one of embodiments 55 to 86, wherein the binder comprises a carbohydrate.

Embodiment 88. The method of any one of embodiments 55 to 87, wherein the binder comprises dextrin.

Embodiment 89. The method of any one of embodiments 55 to 88, wherein the combined second and third coating makes up at least 30% by weight of the core.

Embodiment 90. The method of any one of embodiments 55 to 89, wherein the combined second and third coating makes up at least 40% by weight of the core.

Embodiment 91. The method of any one of embodiments 55 to 90, wherein the second coating makes up 20 to 100% by weight of the core.

Embodiment 92. The method of any one of embodiments 55 to 91, wherein the second coating makes up 30 to 80% by weight of the core.

Embodiment 93. The method of any one of embodiments 55 to 92, wherein the second coating comprises at least 80% by weight w/w of a salt having a constant humidity at 20° C. of at least 85%.

Embodiment 94. The method of any one of embodiments 55 to 93, wherein the second coating comprises at least 90% by weight w/w of a salt having a constant humidity at 20° C. of at least 85%.

Embodiment 95. The method of any one of embodiments 55 to 94, wherein the second coating comprises sodium sulfate.

Embodiment 96. The method of any one of embodiments 55 to 95, wherein the third coating makes up 0.5 to 20% by weight of the core.

Embodiment 97. The method of any one of embodiments 55 to 96, wherein the third coating makes up 0.5 to 10% by weight of the core.

Embodiment 98. The method of any one of embodiments 55 to 97, wherein the third coating makes up 1 to 10% by weight of the core.

Embodiment 99. The method of any one of embodiments 55 to 98, wherein the third coating makes up 1 to 10% by weight of the core.

Embodiment 100. The method of any one of embodiments 55 to 99, wherein the third coating comprises a film-forming agent.

Embodiment 101. The method of embodiment 100, wherein the film-forming agent is a film-forming polymer.

Embodiment 102. The method of embodiment 100 or 101, wherein the film-forming agent is polyethylene glycol, hydroxypropyl methyl cellulose (HPMC or MHPC), or polyvinyl alcohol (PVA).

### EXAMPLES

Chemicals used in the Examples were commercial products of at least reagent grade.

### Example 1

### Influence of Salt Coating and Bleach Catalyst Particle Size

The experiment was conducted to show the positive impact of increasing the thickness of the salt coating and reducing the particle size of the bleach catalyst.

The experiment was done by using scanning electron microscopy (SEM-EDX) with granules which were cut to examine the coverage and exposure of bleach catalyst material to the exterior.

Two different granules were prepared:
Granule (a): non-milled bleach catalyst particles (D₉₀˜200 μm) and approximately 25% (w/w) salt coating were applied onto an inert core.
Granule (b): milled bleach catalyst particles (D₉₀˜25 μm) and approximately 70% (w/w) salt coating were applied onto an inert core.

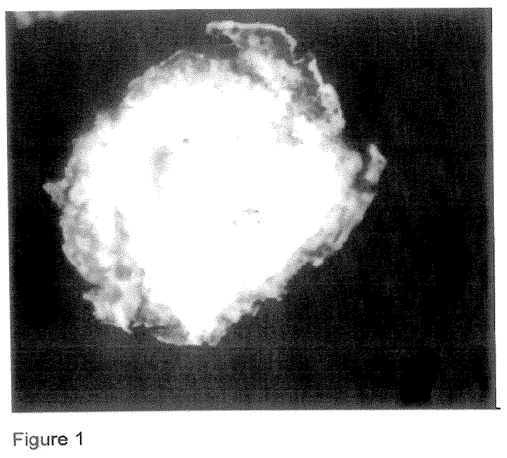

Granule (a) showed poor coating quality and large exposure of bleach catalyst (bad coverage) to the surroundings. The granule had inhomogeneous layers and a fuzzy edge—see also FIG. 1.

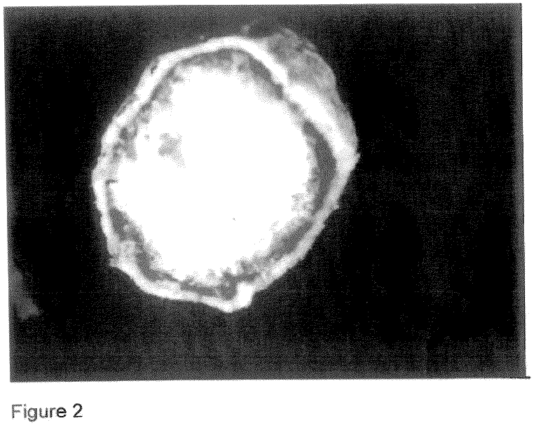

Granule (b) showed good coating quality and no exposure of bleach catalyst (good coverage) to the surroundings. The granule had uniform layers and a clear edge—see also FIG. 2.

### Example 2

### Thermal Activity Measurement of Poor Coverage/Coating of Bleach Catalyst

The experiment was done by measuring heat release when the granule was incubated with a bleach (percarbonate) containing powder detergent. This reveals the contact of bleach catalyst with the bleach source, and indirectly the quality of coating and coverage of bleach catalyst material.

Heat release was measured in a TAM (thermal activity measurement) setup. The coated granules were mixed with the detergent and transferred to TAM ampoules.

Two different granules were prepared by applying bleach catalyst particles and approximately 60% (w/w) salt coating onto an inert core:
Granule (c): the bleach catalyst particles were small enough to be completely covered by the salt coating—similar to Granule (b) in Example 1.
Granule (d): the bleach catalyst particles protruded out of the salt coating—not completely covered by the salt coating—and were thus exposed to the surroundings.

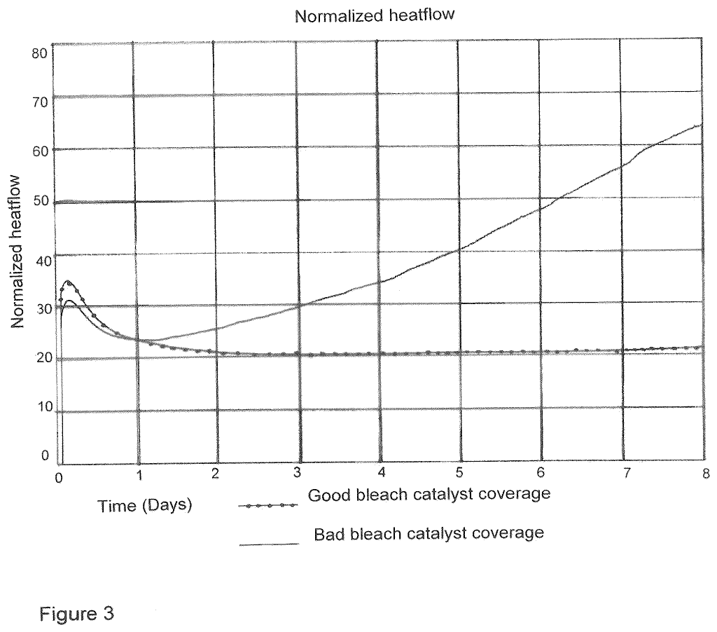

FIG. 3 shows the heat release generated by the two samples during 8 days of incubation in the TAM setup.

Granule (c) created no heat flow and thus no contact of the bleach catalyst with the bleach source in the detergent.

Granule (d) created increased heat flow and thus intensive contact of the bleach catalyst with the bleach source in the detergent.

1-16. (canceled).

17. A dishwash detergent, wherein the detergent is a tablet comprising two or more layers, and wherein the tablet comprises:
(I) a detergent enzyme granule, and
(II) a non-enzymatic granule comprising:
(a) a core particle having a diameter of 250-1200 μm, surrounded by
(b) a first coating which comprises bleach catalyst particles and a binder, which is surrounded by
(c) a second coating comprising at least 80% by weight of the coating of a water-soluble salt selected from the group consisting of Na₂CO₃, Na₂SO₄, K₂SO₄, KHSO₄, MgSO₄, sodium citrate, and combinations thereof, which is surrounded by
(d) a third coating comprising polyethylene glycol or polyvinyl alcohol;
wherein the amount of bleach catalyst in the first coating is in the range of 2 to 15% by weight of the core;
wherein the amount of binder in the first coating is in the range of 1 to 20% by weight of the core;
wherein the combined second and third coating makes up at least 30% by weight of the core; and
wherein the bleach catalyst particles comprise at least 80% by weight of a manganese complex comprising a ligand selected from the group consisting of triazacyclononane, dimethyl triazacyclononane, and trimethyl triazacyclononane, characterized in that the bleach catalyst particles have a volume average particle size D₉₇ in the range of 10 to 30 μm.

18. The dishwash detergent of claim 17, wherein the manganese complex has the below formula (1) or (2): 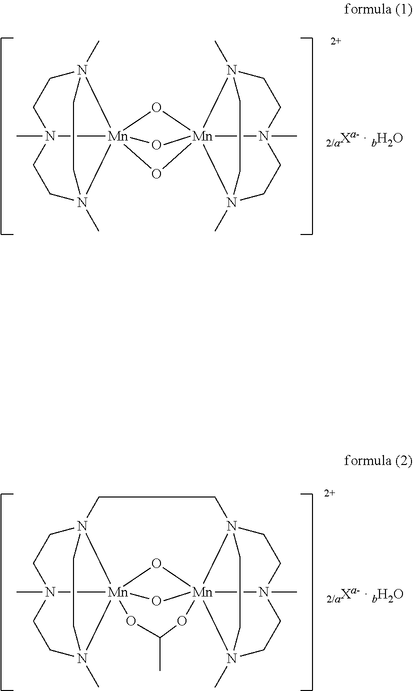
wherein a is 1 or 2, b is a number from 0 to 4, and X is any monovalent or divalent anion.

19. The dishwash detergent of claim 17, wherein the manganese complex is bis(N,N′,N″-trimethyl-1,4,7-triazacyclononane)-trioxo-dimanganese (IV) di(hexafluorophosphate) monohydrate.

20. The dishwash detergent of claim 17, wherein the average thickness of the first coating is in the range of 1 to 15 μm.

21. The dishwash detergent of claim 17, wherein the average total thickness of the second and third coating is at least 400% of the thickness of the first coating.

22. The dishwash detergent of claim 17, wherein the average total thickness of the second and third coating is at least 20 μm.

23. The dishwash detergent of claim 17, wherein the second coating makes up 20-100% by weight of the core.

24. The dishwash detergent of claim 17, wherein the second coating comprises sodium sulfate.
